(19) United States
(12) Patent Application Publication
(10) Pub. No.: US 2012/0137535 A1
(43) Pub. Date: Jun. 7, 2012

(54) AIR DEHUMIDIFIER FOR USE IN A DRYER

(75) Inventors: Fabian Sieben, Leverkusen (DE); Theodor Völkel, Erkrath (DE)

(73) Assignee: Henkel AG & Co., KGaA, Dusseldorf (DE)

(21) Appl. No.: 13/398,187

(22) Filed: Feb. 16, 2012

Related U.S. Application Data
(63) Continuation of application No. PCT/EP2010/061223, filed on Aug. 2, 2010.

(30) Foreign Application Priority Data
Aug. 17, 2009 (DE) 10 2009 028 594.6

(51) Int. Cl. F26B 13/26

(52) U.S. Cl. 34/95

(57) ABSTRACT

The invention relates to a drying device, comprising a molded part, which has a hollow chamber formed by one or more inside walls, and one or more outside walls, wherein a superabsorbent material is provided between the inside wall(s) and the outside wall(s), and at least one wall is permeable for water and/or water vapor. The drying device can be used in a clothes dryer for reducing the drying time.

### CROSS-REFERENCES TO RELATED APPLICATIONS

This application is a continuation of PCT/EP2010/061223, filed on Aug. 2, 2010, which claims priority under 35 U.S.C. §119 to DE 10 2009 028 594.6 filed on Aug. 17, 2009, both of which are hereby incorporated by reference.

### FIELD OF THE INVENTION

The present invention generally relates to a drying device, comprising a molded part having a hollow chamber formed by one or more inner walls and one or more outer walls. The invention also relates to the use of such a drying device.

### BACKGROUND OF THE INVENTION

In the meantime, dryers have been used in many households for drying laundry with hot air. The dryers are typically categorized as a tumble dryer, a condenser dryer and a heat pump dryer, based on the drying method.

In the tumble dryer, humid air produced after drying laundry is sent to the outside. In the condenser dryer, humid air produced after drying laundry undergoes heat exchange with outside air and the humid air is condensed to be converted into dry air. Then the dry air is heated and returned to the laundry. The heat pump dryer functions according to the heat pump principle. Thus the hot part of the heat pump heats the incoming air and moisture condenses out of the exhaust air on the cold part.

Although heat pump dryers already consume much less energy than condenser dryers or tumble dryers, clothes dryers have a high power consumption and are among the highest power consumers in a household. To shorten the drying process in the clothes dryer and thereby reduce power consumption, the laundry should first be spun at a high spin speed in the washing machine. The lower the residual moisture content of the laundry after washing, the shorter will also be the drying time in the dryer. However, high spin speeds result in much greater wrinkling of many textiles.

US 2008/0104856 A1 describes a ball having openings for use in a dryer, this ball being at least partially coated with a hydrophilic fabric, which absorbs moisture from wet laundry and dries the laundry extremely rapidly. The interior of the ball may serve to absorb moisture from the hydrophilic fabric.

However, there is also a need for providing measures which further reduce the time required for drying laundry in a dryer. In particular there is a demand for measures which do not necessitate any technical changes in the clothes dryers.

This need is covered by a drying device for use in a clothes dryer comprising a molded part having a hollow chamber formed by one or more inner walls and having one or more outer walls, such that a superabsorbent material is provided between the inner wall(s) and outer wall(s), at least one wall being permeable for water and/or water vapor.

Furthermore, other desirable features and characteristics of the present invention will become apparent from the subsequent detailed description of the invention and the appended claims, taken in conjunction with this background of the invention.

### BRIEF SUMMARY OF THE INVENTION

A drying device for use in a clothes dryer, comprising a molded part, which has a hollow chamber formed by one or more inside walls, and one or more outside walls, such that a superabsorbent material is provided between the inside wall(s) and the outside wall(s), and at least one wall is permeable for water and/or water vapor.

Use of a drying device comprising a molded part, which has a hollow chamber formed by one or more inner walls, and one or more outer walls, such that a superabsorbent material is provided between the inner wall(s) and the outer wall(s) and at least one wall is permeable for water and/or water vapor, in a clothes dryer for reducing the drying time.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

The presence of a superabsorbent material during the drying process causes water and/or water vapor formed due to the evaporation of water from the laundry being dried to be absorbed by the superabsorbent material and thus removed from the system more rapidly than would be the case through tumble dryer processes, condenser dryer processes or heat pump dryer processes alone. This leads to a reduction in the drying time.

It is preferable for the superabsorbent material to be selected from the group of crosslinked polyacrylic acids, copolymers of acrylic acid, copolymers of acrylamide, graft polymers of starch, crosslinked starches, cellulose derivatives and blends thereof These materials are known materials which absorb water (vapor) and have a high absorption capacity.

In addition, it is preferable for that the drying device to be essentially spherical. An essentially spherical shape of the drying device causes the drying device to be moved uniformly in the dryer drum during operation, to become entangled less easily with the laundry and/or to minimize noise emissions caused by the drying device.

It is preferable for the vapor entering the molded part to be condensed in the hollow chamber.

At a constant temperature, an equilibrium state is established on a water-laden surface, separating liquid water from the air volume above it. In the equilibrium state, the rate of condensation and the rate of evaporation are the same, i.e., just as many water molecules go from water into air as from air into water per unit of time. The concentration of water molecules in air in the equilibrium state is the saturation concentration.

If the supply of water molecules into the hollow chamber of the molded part is increased continuously through suitable measures to above its saturation concentration (supersaturation), the water vapor utilizes a condensation surface that is available to reduce its concentration to the saturation concentration by heterogeneous condensation. Water vapor is thus also withdrawn continuously from the system of “liquid water in the moist laundry” ⇄ “water vapor in the dryer drum” and more water is evaporated from the damp laundry.

The saturation concentration within the hollow chamber can be exceeded easily and a heterogeneous condensation of the water vapor can be induced through the measure whereby the molded part has an opening designed so that it makes it difficult for water vapor to escape out of the molded part.

It is especially preferable that a material having a thermal conductivity of ≦2 W/(cm·K) (determined according to DIN 52 612) is provided in the interior of the hollow chamber.

In an advantageous embodiment of the invention, the side(s) of the inner wall(s) in the hollow chamber is (are) made of a material having a thermal conductivity of ≦2 W/(cm·K) (determined according to DIN 52 612).

In another advantageous embodiment of the invention, the side(s) of the inner wall(s) in the hollow chamber is (are) at least partially coated with a material having a thermal conductivity of ≦2 W/(cm·K) (determined according to DIN 52 612).

In yet another advantageous embodiment of the invention, the hollow chamber of the molded part is filled completely with a material having a thermal conductivity of ≦2 W/(cm·K) (determined according to DIN 52 612).

In all embodiments of the invention, the water vapor entering the hollow chamber condenses on the material having the low thermal conductivity and is thereby removed from the system of “liquid water in the moist laundry” “water vapor in the dryer drum.”

If the hollow chamber of the molded part is completely filled with a material having a thermal conductivity of ≦2 W/(cm·K), then it is advantageous that the outer wall(s) of the molded part is (are) surrounded by a unidirectional membrane, allowing water vapor to enter the molded part but not to leave it.

In an alternative embodiment, the inner wall(s) of the molded part is (are) formed from a polymer material, which expands during operation of the clothes dryer.

In another embodiment of the invention, which is also advantageous, a polymer material in the form of a balloon, which expands during operation of the clothes dryer, is also located in the hollow chamber of the molded part.

In operation of the clothes dryer, the polymer material expands and the circumference of the hollow chamber and/or of the balloon increases. Due to the increase in volume, a reduced pressure is established in the interior of the hollow chamber and/or balloon, and hot humid air is drawn out of the dryer drum. Water vapor condenses out of the hot humid air and then on the inside surface of the hollow chamber and/or balloon.

It is preferable in particular for the inner wall(s) of the molded part to have water-permeable openings.

The water condensed in the hollow chamber reaches the superabsorbent material through these openings and is irreversibly absorbed by it.

The invention also relates to the use of a drying device comprising a molded part having a hollow chamber formed by one or more inner walls and having one or more outer walls, such that a superabsorbent material is provided between the inner wall(s) and the outer wall(s), and at least one wall is permeable for water and/or water vapor, in a clothes dryer to reduce drying time.

The invention is described in greater detail below on the basis of examples.

The drying device comprises a molded part having a hollow chamber formed by one or more inner walls in its interior.

The molded part is preferably essentially spherical and thus has only one inner wall. Alternatively, the molded part may also have a different shape and may be, for example, egg-shaped, cubic, quadratic, cuboid, disk-shaped or cylindrical, for example. Except for an egg-shaped hollow chamber, the hollow body then has multiple walls, mainly two opposing base walls and one side wall. It may be preferable for the molded part not to have any planar wall. It may be preferable for the wall of an egg-shaped or spherical molded part to have an area of a low curvature, so that the drying device will have a standing surface. In the case of cubic, quadratic or cuboid molded parts, it may be preferable for the corners of the hollow parts to be rounded.

The inner wall(s) may either be dimensionally stable or they may expand during operation of the clothes dryer.

If the inner wall(s) is (are) stable, then it (they) is (are) preferably made of a thermoplastic polymer such as polyvinyl chloride (PVC), polyethylene with a high or low density (HDPE or LDPE), polyethylene terephthalate (PET), polypropylene (PP), polystyrene, polyamide or blends of same.

These thermoplastic polymers have a low thermal conductivity of ≦2 W/(cm·K).

The thermal conductivity is a measure of the thermal conduction in a homogeneous body and has the dimension W/(cm·K). The thermal conductivity (determined according to DIN 52 612) of polyvinyl chloride is 0.15 W/(cm·K), that of high density polyethylene is 0.41 W/(cm·K), that of high density polyethylene is 0.3 W/(cm·K), that of polyamide is 0.23 W/(cm·K), that of polypropylene (homopolymer) is 0.22 W/(cm·K) and that of polyethylene terephthalate is 0.24 W/(cm·K).

If the inner, dimensionally stable wall(s) is (are) made of a material having a thermal conductivity of ≦2 W/(cm·K), it may be preferable for the side of the inner, dimensionally stable wall(s) in the hollow chamber to be coated at least partially with a material having a thermal conductivity of ≦2 W/(cm·K).

The outer wall(s) may be made of one of the aforementioned thermoplastic polymers and thus may also be dimensionally stable. Alternatively, the outer wall(s) may comprise a unidirectional membrane. The Sympatex© [sic®] membrane, which is permeable for water vapor but not for liquid water, is especially suitable as the unidirectional membrane.

The inner, dimensionally stable walls and/or the outer, dimensionally stable wall(s) of the molded part is (are) produced by the injection molding method. It is also possible to incorporate biocidal metals and/or metal ions into the thermoplastic polymer material.

If the molded part is essentially spherical, it is preferable for the inner wall of the molded part to be designed in one piece. If the outer wall is also made of a thermoplastic polymer, it is preferable for the outer wall to be made in two pieces, preferably two mutually releasably or nonreleasably engaged half-shells. If the outer wall comprises a unidirectional membrane, then the outer wall may consist of two or more individual parts, which are glued or stitched together to form an outer wall.

Alternatively, the inner wall of an essentially spherical molded part may be formed from a polymer material, which expands during operation of the clothes dryer. In this embodiment of the invention, the outer wall is preferably also formed from this polymer material.

If the inner wall of the molded part is formed from a dimensionally stable material, then alternatively, a balloon of a polymer material, which expands during operation of the clothes dryer, may also be provided in the hollow chamber of the hollow body.

In most embodiments, it is preferable for the molded part to have an opening through which hot humid air goes from the dryer drum into the hollow chamber of the molded part. This is true in particular of the embodiments in which the hollow chamber is not filled completely by material, for example, a material having a thermal conductivity of ≦2 W/(cm·K). If a balloon of a polymer material, which expands during operation of the clothes dryer, is in the interior of the hollow chamber, it is preferable for the opening of the balloon to be connected to the opening in the molded part and for the hot humid air to go out of the dryer drum into the interior of the balloon after passing through the opening in the molded part.

The opening in the molded part may be closable. In this embodiment, the closure is preferably a bimetal strip. The metals in a bimetal strip that can be used according to the invention are joined together and applied to the opening of the molded part in such a way that they expand differently during operation of the clothes dryer and the resulting change in temperature, so that the opening in the molded part is closed. At the end of the drying operation and/or cooling, the bimetal strip returns back to its original shape.

It is preferable in particular for the opening to be designed so that water vapor enters the hollow chamber more easily than leaves it, which thus has the result that water vapor entering the molded part is condensed in the hollow chamber. This may be accomplished by the fact that the opening has a funnel shape, for example, and the diameter of the opening in the area of the outer wall is larger than the diameter of the opening in the area of the inner wall.

It may also be preferable for the molded part to have more than one opening.

Depending on the embodiment, it is preferable for the inner wall(s) of the molded part to have water-permeable openings, which conduct the condensed water in the direction of the superabsorbent material, by which it is irreversibly absorbed and thereby removed from the drying process. If there is a balloon made of a polymer material, which expands during operation of the dryer and is in the interior of the hollow chamber, then it is preferable for the balloon to also have water-permeable openings and for condensed water in the interior of the balloon to enter the hollow chamber and to go from there through the water-permeable openings in the inner wall(s) to the superabsorbent material.

The superabsorbent material is preferably selected from the group comprising crosslinked polyacrylic acids, copolymers of acrylic acid, copolymers of acrylamide, graft polymers of starch, crosslinked starches, cellulose derivatives and blends thereof.

The superabsorbent material is preferably present in granular form. The diameter of a granule is larger than the diameter of the opening(s) in the hollow chamber and also larger than the diameter of the water-permeable openings in the inner wall(s).

It may also be preferable for the outer wall to have a closable opening for filling and emptying the additional hollow chamber between the inner wall and the outer wall with the superabsorbent material. The closable opening is a screw cover, a stopper, a slide or a lockable valve, for example. It may also be preferable for one or more spacers in the form of crossbars made of one of the aforementioned thermoplastic polymers, for example, to be provided between the inner wall(s) and the outer wall(s).

The outer diameter of the molded part is preferably between 5 cm and 20 cm, in particular preferably 8 cm.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A drying device for use in a clothes dryer, comprising a molded part, which has a hollow chamber formed by one or more inside walls, and one or more outside walls, such that a superabsorbent material is provided between the inside wall(s) and the outside wall(s), and at least one wall is permeable for water and/or water vapor.

2. The drying device for use in a clothes dryer according to claim 1, wherein the superabsorbent material is selected from the group of crosslinked polyacrylic acids, copolymers of acrylic acid, copolymers of acrylamide, graft polymers of starch, crosslinked starches, cellulose derivatives and mixtures thereof.

3. The drying device for use in a clothes dryer according to claim 1, wherein the drying device is essentially spherical.

4. The drying device for use in a clothes dryer according to claim 1, wherein water vapor entering the molded part is condensed in the hollow chamber.

5. The drying device for use in a clothes dryer according to claim 1, wherein the molded part has an opening which is designed so that it makes it difficult for water vapor to escape from the molded part.

6. The drying device for use in a clothes dryer according to claim 1, wherein a material having a thermal conductivity of ≦2 W/(cm·K) (determined according to DIN 52 612) is situated in the interior of the hollow chamber of the molded part.

7. The drying device for use in a clothes dryer according to claim 1, wherein the side(s) of the inside wall(s) of the hollow chamber which are in the hollow chamber are made of a material having a thermal conductivity of ≦2 W/(cm·K) (determined according to DIN 52 612).

8. The drying device for use in a clothes dryer according to claim 1, wherein the side(s) of the inside wall(s) in the hollow chamber is (are) coated with a material having a thermal conductivity of ≦5 W/(cm·K) (determined according to DIN 52 612).

9. The drying device for use in a clothes dryer according to claim 1, wherein the hollow chamber of the molded part is filled completely with a material having a thermal conductivity of ≦2 W/(cm·K) (determined according to DIN 52 612).

10. The drying device for use in a clothes dryer according to claim 1, wherein the outer wall(s) of the molded part is (are) formed by a unidirectional membrane which allows water vapor to enter the molded part but does not allow it to leave.

11. The drying device for use in a clothes dryer according to claim 1, wherein the inner wall(s) of the molded part is (are) made of a polymer material which expands during operation of the clothes dryer.

12. The drying device for use in a clothes dryer according to claim 1, wherein a polymer material in the form of a balloon which expands during operation of the clothes dryer is in the hollow chamber of the molded part.

13. The drying device for use in a clothes dryer according to claim 1, wherein the inner wall(s) of the molded part has/have water-permeable openings

14. The drying device for use in a clothes dryer according to claim 5, wherein the opening is sealed by a bimetal during operation of the clothes dryer.
